(19) United States
(12) Patent Application Publication
(10) Pub. No.: US 2007/0036278 A1
(43) Pub. Date: Feb. 15, 2007

(54) System, method and computer program product for interactive voice notification and product registration

(75) Inventors: Brian Lichorowic, Middleburg, VA (US); Xia Zhang, Sterling, VA (US); Bala Sundaram, Herndon, VA (US)

Correspondence Address: VENABLE LLP, P.O. BOX 34385, WASHINGTON, DC, 20043-9998, US

(73) Assignee: Audiopoint, Inc., Rockville, MD (US)

(21) Appl. No.: 11/293,510

(22) Filed: Dec. 5, 2005

Related U.S. Application Data
(63) Continuation-in-part of application No. 10/858,285, filed on Jun. 2, 2004.

(30) Foreign Application Priority Data
Jun. 2, 2005 (WO) PCT/US05/19436

(51) Int. Cl. H04M 11/04

(52) U.S. Cl. 379/37

(57) ABSTRACT

A notification system and an automated product registration system are disclosed. The notification system may contact multiple persons simultaneously and use text-to-speech to speak a message to each person over the phone. The notification system may first determine whether a live person has answered the phone before speaking the message. The notification system may be used in conjunction with an automated voice-activated product registration system.

### RELATED APPLICATIONS

The present invention is a continuation-in-part of U.S. application Ser. No. 10/858,285, filed Jun. 2, 2004, entitled “System, Method and Computer Program Product for Interactive Voice Notification”; and of PCT Application No. PCT/US2005/019436, filed Jun. 2, 2005, entitled “System, Method and Computer Program Product for Interactive Voice Notification”, the contents of both of which are incorporated by reference in their entirety.

### BACKGROUND OF THE INVENTION

1. Field of the Invention

The present invention relates generally to automatic notification systems, and more particularly to automatic notification systems that provide voice interaction.

2. Related Art

As society becomes both more mobile and more dependent on the instantaneous dissemination of information, there is a need both for notification of important information and the ability to confirm that an individual has received the information.

For example, in an emergency, a team of volunteer responders, such as a team of volunteer firefighters or a search-and-rescue team needs to be contacted immediately to see who is nearby and available. Conventionally, such life-critical dispatching operations are left to human operators. Human operators can ensure that they have reached the appropriate person and determine whether that person can respond to the emergency. Human operators, however, are not efficient, especially if several phone numbers or other access methods must be tried for each person to be reached.

There are also numerous non-emergency examples of automated conventional notification. There are devices that can inform a user when the user receives an e-mail message and can allow the user to read the message. There are services that can send stock updates, sport scores, weather alerts, traffic updates or other variable information to pagers or other text message capable devices. These services are quite efficient at providing information and do not require a human dispatcher. However, there is no way to determine if the intended recipient actually received the message. People often forget to bring their pagers with them, or receiving devices can fail for any of a variety of reasons, such as dead batteries or being outside of a service area. At best, such services can determine whether the device received the notification, but are not able to ensure that the intended recipient received the notification.

Another disadvantage to such automated information notification systems is that a user can very quickly be inundated with information that the user is not interested in. This is a problem in particular for e-mail notification systems, where the user is notified of all e-mail, e.g., on a store and forward basis, regardless of whether the message is unsolicited junk (“spam”) or an expected message.

Yet another disadvantage to current notification systems is the potential need for the user to carry multiple devices. A user might need, for example, some combination of a pager, a mobile telephone, a personal digital assistant (PDA), and a two-way communication device such as, e.g., a BLACKBERRY® device from Research in Motion, Ltd. of Canada to receive e-mails, voice mail, stock alerts, etc. Having to invest in so many different devices, maintaining and upgrading devices, and paying for wireless connectivity can be expensive.

Some services now offer the ability to retrieve e-mail messages over the telephone, by using text-to-speech (TTS) technology to read a text message to the listener. These services, however, do not inform the user when a message has arrived. Instead, the user must call in and sift through all messages in the user's in-box.

### SUMMARY OF THE INVENTION

In an exemplary embodiment of the present invention a system, method and computer program product for interactive voice notification is disclosed. In one exemplary embodiment, a method for notifying a user of an event can include the steps of: receiving user input on notification criteria; listening for an event; detecting the event; calling the user by telephone when the detected event matches the notification criteria; requesting a user response indicating a live person answered the telephone; receiving the user response indicating the live person answered the telephone; and providing the user with information about the event.

In an exemplary embodiment, the method can further include: requesting a user authentication; determining if the user authentication is valid; and not providing the user with the information about the even if the authentication is not valid.

In another exemplary embodiment, the method can further include: storing the detected event in a database; and querying the database for events matching the notification criteria.

In an exemplary embodiment, listening for an event can include: checking at least one e-mail server for e-mail for the user; checking the user's calendar and other event sources based on the rules set-up by the user; checking for an unscheduled event; checking for a scheduled event; checking for a pager alert; checking for stock quotes; checking for emergency dispatches; checking for financial system alerts; checking for classified advertisement responses; checking for commercial sale alerts; checking for traffic alerts; checking for weather alerts; checking for amber alerts; checking for homeland security advisories; checking for voice messages; checking for faxes; or checking for online auction bid alerts.

In an exemplary embodiment, the method can further include speaking the information about the event to the user.

In an exemplary embodiment, the method can further include receiving user input comprising an action to take based on the event.

In an exemplary embodiment, the notification criteria can include at least one of: an event type, an event criterion, a notification time period, and a user notification telephone number.

In an exemplary embodiment, the event can include an Amber alert or an emergency response dispatch.

In an exemplary embodiment, the event can include one of an e-mail message, a fax, a pager alert, a stock quote, a voice mail message, an Amber alert, an emergency response dispatch, an auction bid alert, a schedule change alert, a schedule reminder alert, a traffic alert, a weather alert, a financial system alert, a classified advertisement response, and a commercial sale alert.

In another exemplary embodiment, of the invention a voice services system, method and computer program product is set forth. In an exemplary embodiment, the system can include: a voice services platform including: a content management system; and an email-by-phone system coupled to the content management system having an application programming interface for programming the email-by-phone system; a text-to-speech system for synthesizing speech from text coupled to the voice services platform; and a notifier coupled to the voice services platform.

In an exemplary embodiment, the system can include one or more POP mail servers coupled to the content management system operative to receive inbound events.

In an exemplary embodiment, the notifier can include being operative to send outbound telephonic notifications.

In an exemplary embodiment, the telephonic notifications can include: a scheduled or unscheduled telephonic notification.

In an exemplary embodiment, the telephonic notifications can include a delivery verification.

In an exemplary embodiment, the delivery verification can include detection of presence of a user. In an exemplary embodiment, the detection can include: receipt of a key depression; or receipt of at least one of a username and a password. In another exemplary embodiment, the detection can include a Turing test.

In an exemplary embodiment, the system can further include a Turing test including receipt of a correct response from the user to a prompted query.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of an embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a high level view of an exemplary notification system according to the present invention;

FIG. 2 depicts an exemplary embodiment of a more detailed view of an exemplary notification system according to the present invention;

FIG. 3 depicts an exemplary embodiment including exemplary interfaces to mail servers and additional exemplary details of an exemplary voice services platform according to the present invention;

FIG. 4 depicts an exemplary embodiment of a flow diagram illustrating an exemplary call flow that can be performed as part of an unscheduled or scheduled event receipt notification, and exemplary user acknowledgement and optional authentication according to the present invention;

FIG. 5 depicts an exemplary embodiment of a notification system including exemplary listeners, event storage, call drivers, agents according to exemplary embodiments of the present invention; and

FIG. 6 depicts an exemplary embodiment of a computer system that can be used in any of various computing and communications devices according to the present invention.

### DETAILED DESCRIPTION OF AN EXEMPLARY EMBODIMENT OF THE PRESENT INVENTION

An exemplary embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

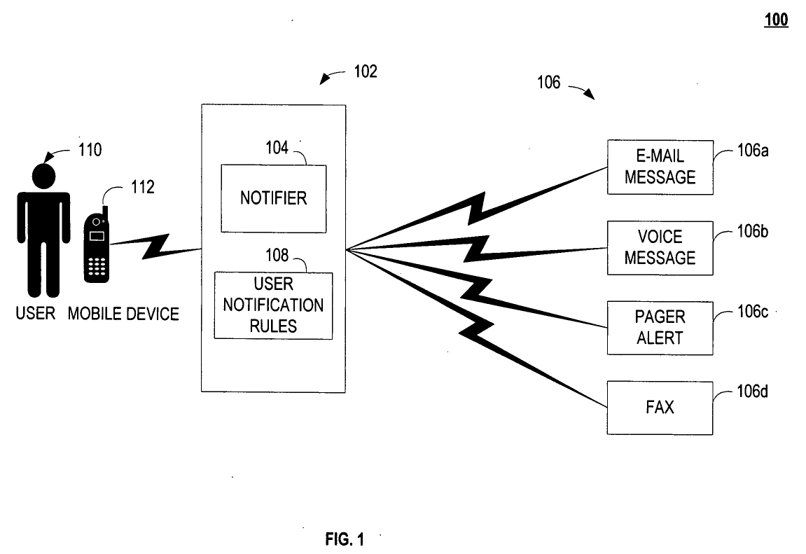

FIG. 1 illustrates a high-level view 100 of an exemplary embodiment of notification system according to the present invention. In a computer system 102, a notifier 104 receives notification events 106, such as, for example, an e-mail message 106a, a voice mail message 106b, a pager alert 106c, or a fax 106d intended for the user. The notifier 104 has access to a set of user notification rules 108 that have been configured by the user 110. The user notification rules 108 can define what types of events should trigger a notification, when those events should occur, the source of the event, when to notify the user 110 and at what telephone number of mobile device 112 to notify the user 110. For example, a rule 108 might specify that the user 110 should be notified at a specific phone number between 2:00 p.m. and 4:00 p.m. today when an e-mail 106a from John Smith is received between 11:00 a.m. and 3:00 p.m. If the received notification event 106 matches a user notification rule 108, the notifier 104 telephones the user 110 at the specified number of mobile device 112. When the user 110 answers the call, the notifier 104 can require the user 110 to interact with the notifier 104. This interaction shows that a person (user 110) rather than an answering machine has answered the call. The notifier 104 can also require that the user authenticate himself/herself as the intended recipient. For example, the user 110 may enter a key sequence to identify oneself, provide other identification, or may enter a personal identification number (PIN) via the telephone keypad. When the notifier 104 determines that a human answered the call and that the PIN that was provided matched the identity of the intended recipient, then notifier 104 deduces that the correct live person, user 110, has answered the call, the event can be played as a text-to-speech message to the user 110.

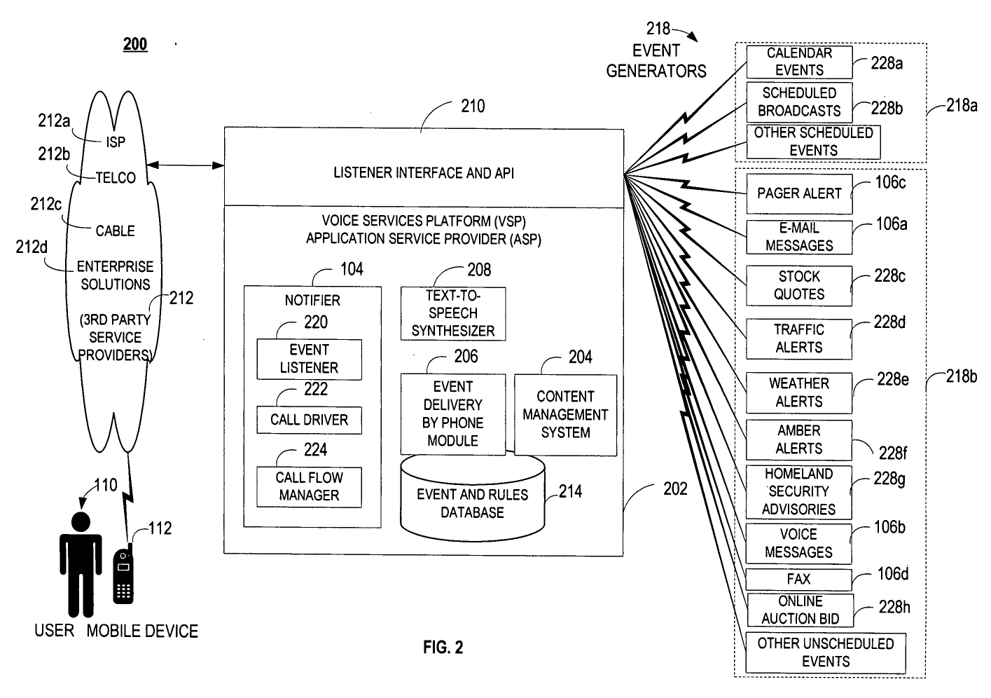

FIG. 2 depicts an exemplary embodiment of a more detailed view 200 of the notification system according to the present invention. An exemplary embodiment of the present invention has a voice services platform 202 that comprises a content management system 204, an event delivery-by-phone module 206 and event database 214 coupled to the content management system 204. The voice services platform 202 is coupled to a text-to-speech synthesizer system 208 for synthesizing speech from text. A notifier 10A interacts with the content management system 204 and the text-to-speech synthesizer system 208, to inform an user 110 at mobile device 112 of an event 218a, 218b of interest to the user 110. The voice services platform application service provider (ASP) 202 in an exemplary embodiment can include an application programming interface (API) 210 that allows third-party service providers 212, such as, e.g., Internet service providers (ISPs) 212a, telephone companies 212b, cable companies 212c and enterprise solution providers 212d, to provide such exemplary services as e-mail by phone, event notification and text-to-speech services without having to develop their own systems. Notifier 104 in exemplary embodiment is a module including various components such as, e.g., event listener 220, call driver 222 and a call flow manager 224 event notification application. Notifier 104 can provide notifications or alerts related to scheduled events 218a and unscheduled events 118b, received from event generators 118. Exemplary scheduled events 218a include calendar events 228a, and scheduled broadcasts 228b. Exemplary non-scheduled events 218b include, but are not limited to, pager alert 106c, email messages 106a, stock quotes 228c, traffic alerts 228d, weather alerts 228e, amber alerts 228f, homeland security advisories 228g, voice messages 106b, faxes 106d, and online auction bid alerts 228h.

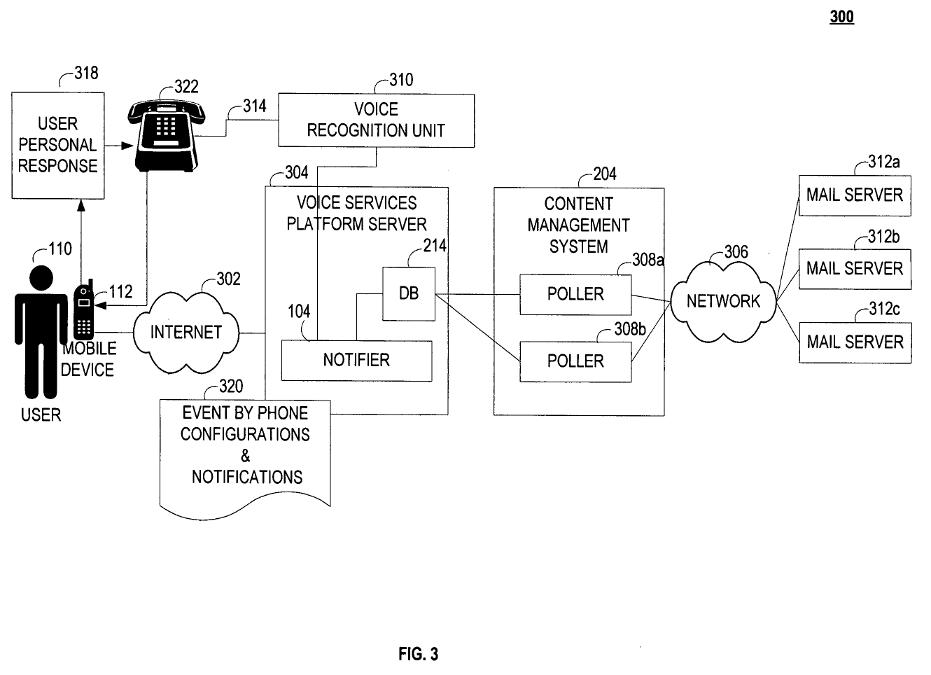

FIG. 3 depicts diagram 300 illustrating an exemplary embodiment of a user notification confirmation system of the present invention. A user 110 connects through the Internet 302 to a voice services platform server 304. The user 110, using the voice services platform server 304, can configure one or more user notification rules 108. A notification rule 108 can specify, e.g., what type of event to look for, such as, for example, an e-mail message 106a, a pager alert 106c, a stock quote 228c, or an on-line auction bid alert 228h. The user 110 can also specify certain characteristics of the event to look for, such as, for example, the sender or originator, the time event was sent, the subject of the event, the urgency level, etc. The user 110 can then specify a time period during which to look for receipt of the event. Finally, the user 110 can specify a date and time to be notified of the events received, and the phone number of device 112 at which the user can be reached during that time period. In an exemplary embodiment the device 112 is mobile, but the device need not be. If necessary, the user 110 can specify multiple phone numbers for different time periods. The server 304 can store the notification rules 108 in an event database 214. The notification rules 108 can be accessed several ways. For example, notification rules 108 can be accessed by the user 110 over the Internet 302 using a web browser to create, review, update and delete. Alternatively, the notification rules 108 can be assessed by the event listener 220 of the notifier system 104 to identify events that need outbound calls made. The content management server (CMS) 204 can be coupled to a network 306, such as, e.g., the Internet 302 or an internal network. The CMS 204 can have one or more pollers 308a, 308b, which detect events 218a, 218b, for example, e-mail messages 106a, for user 110. The pollers 308a, 308b can detect e-mail 106a from multiple e-mail accounts at multiple mail servers 312a, 312b and 312c, for a single user, such as, for example, from Hotmail, Yahoo mail, MSN mail, AOL mail, or any other internet service provider (ISP) electronic mail service provider.

When a poller 308a, 308b detects an event 218a, 218b such as an e-mail message 106a, the poller 308a, 308b updates voice services platform server 304 database 214. For applications such as email notification, all emails can be stored. The event listener 220 can compare the emails 106a with the rules 108 established in the database 214. There could be events 218a, 218b that need not be stored in the database 214 at all, but could be triggered from an external source, such as, e.g., a traffic alert broadcast 228d or a weather alert 228e from an external system. The database 214 can store information about the event 218a, 218b and can be searched to find events that match the notification rules 108. The notifier 104 can query the database 214 and when an event 218a, 218b matching the notification rules 108 is found, the notifier 104 can inform a voice recognition unit (VRU) 310. The VRU 310 can then call the user 110 at the number specified in event-by-phone configurations and notifications 320 or the notification rule 108. The VRU 310 can also require in an exemplary embodiment that the user 110 respond to a prompt to show that a person (and not an answering machine) has answered the call, and may require that the user 110 authenticate himself. In one exemplary embodiment, a so-called “Turing test” can be presented to the user for the user 110 to prove that the user 110 is a person and not a machine. When personal responses from user 110 are deemed satisfactory, the VRU 310 can speak text of a first event received to the user. The database 214 can then update that the message was delivered to the user 110. For scenarios that require more interaction with user 110, such as, e.g., changing auction bids 228h or buying stock 228c, third-party service provider systems 212 can be used to receive or send events 218a, 218b.

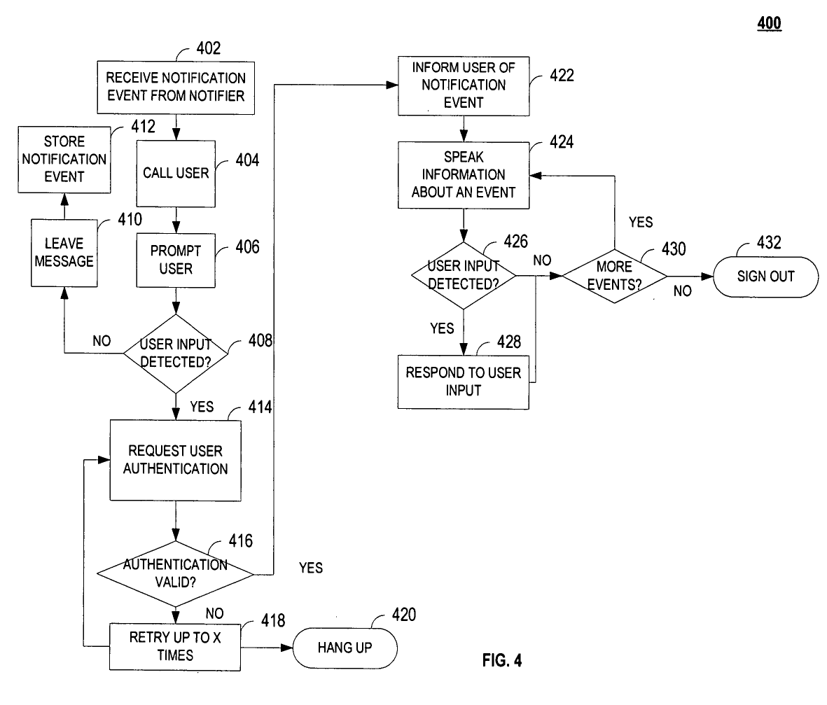

FIG. 4 depicts a flowchart 400 of an exemplary embodiment of a notification sequence according to all exemplary embodiment of the present invention. In block 402, the VRU 310 receives a notification event 218a, 218b from the notifier 104. In block 404, the VRU 310 can call the user 110 at the number specified in the user's notification rules 108 as shown in 314, 316. In block 406, when the phone 112 is answered, the VRU 310 can prompt the user 110 for a personal user response 318, or confirmation of receipt, such as, for example, a key press or other Turing test, or a specific word or phrase. If no confirmation is received in block 408 within a specified period of time, the VRU 310 may assume that an answering machine or voice mail service has answered the call and can leave a message in block 410, or alternatively can note that the caller was inaccessible and queue to retry. The message in block 410 can inform the user 110 that the user 110 has received a notification event 118a, 118b and can provide a phone number 322 where the user 110 can call to retrieve the event at a later time. In block 412, the notification event 118a, 118b can be stored for later retrieval by the user 110 in, e.g., database 214.

If user input is received in block 408, the VRU 310 may then prompt the user for authentication information in block 414, such as, for example, a personal identification number (PIN) typed into the keypad, or a spoken word or phrase identifying the user. If the provided user authentication information is determined to be invalid in block 416, the user can be prompted for the information again in block 418, repeating blocks 414 and 416 until the information is correct resulting in flow diagram 400 continuing with block 422 or until a number of tries (labeled as X) has been used, as shown in block 418. The call can terminate in block 420. If the user 110 is unable to authenticate himself, the VRU 310 can then hang up as shown in block 420.

The VRU 310 can attempt to reach user 110 later for as many times as the user has configured the event configuration 320 for retries. The failed recognition can be counted as one attempt to notify the person. The notifier 104 can have the flexibility to allow the user 110, as an option, to call back at a certain number corresponding to 322 to check in with the system.

When authentication is valid in block 416, the user 110 can then be informed of the notification event as shown in block 422. In block 424, information about the event, such as a subject and a sender, can then be spoken to the user 110, in an exemplary embodiment. In block 426, the VRU 310 can wait for user 110 input. The user 110, can, e.g., choose to listen to the event, skip the event, go to the next event, or hang up. If the user 110 chooses to listen to an event, further user 110 input can be entered at any time. Each call, in an exemplary embodiment, can be managed by call flow manager 224. For example, the user 110 can choose to save, replay, delete, skip, reply, go to the next event or sign out of the system while the event is playing. When user input is detected or received in 426, the VRU 310 can respond appropriately in blocks 428 and 424 as necessary to speak further information. At the end of the event, the VRU 310 can continue to wait for user input in block 426 until there are no more events to play for the user 110 as determined in block 430. When there are no more events, the user 110 can be signed out in block 432 and the VRU 310 can hang up.

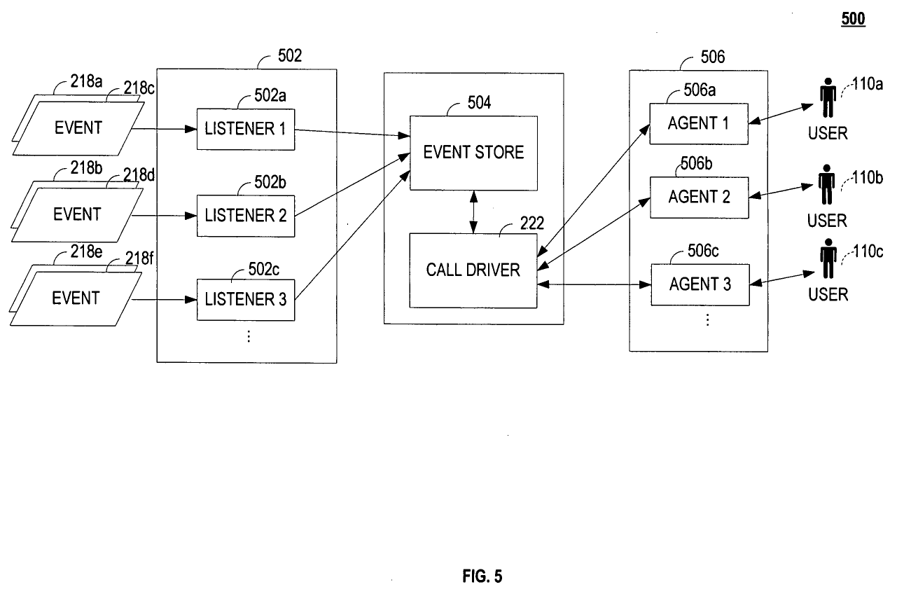

FIG. 5 illustrates another view 500 of an exemplary embodiment of the notification system of the present invention where the notification system uses one or more listeners 502a, 502b and 502c in a listener pool 502. In an exemplary embodiment, each listener 502a, 502b, 502c listens for only one type of event. As a listener 502a, 502b, 502c receives an event, it can inform the event store 504. The event store 504 can store the event, and can push the event to a call driver 222. The call driver 222 can then forward the event to an agent 506a, 506b, 506c in an agent pool 506. The agent 506a, 506b, 506c can then notify the user 110. The notification system 500 can receive input from the user 110 (such as, e.g., in responding to an online auction bid alert 228h). That input can flow back from the user 110 as a regular voice recognition application over the telephone 112. The diagram 500 shows double-ended arrows between users 110a, 110b, 110c and agents 506a, 506b, 506c, respectively, as well as in turn from agents 506a, 506b, 506c, on to call driver 222 showing interactivity between call driver 222 and users 110.

The system and method of the present invention can be used in a variety of settings. For example, the method illustrated in diagram 400 can be used to dispatch a “call tree” of emergency responders. For example, homeland security advisories 228g can be provided. In the emergency services dispatching example described, all of the emergency responders can have their various methods of being contacted entered as the emergency responders' notification rules 108. In the event of an emergency, the automated system can, in an exemplary embodiment, advantageously call each responder (e.g. users 110a, 110b, and 110c) concurrently, and can deliver the dispatch instructions in parallel. The human input requirement can allow the system to determine if the appropriate person has received the message. The message delivery information can be fed back to a dispatch center and can be displayed in some way to a human dispatcher. The human dispatcher can then see quickly how many responders are available and can stop the event notification system when enough responders have been reached. Automating dispatch according to the present invention frees the dispatcher to receive more emergency calls from those in distress and can greatly improve response time.

In another example, the system of the present invention can be used in an “Amber Alert” 228f notification system to notify users and law enforcement officers of when a child has been abducted in their area.

In another exemplary embodiment, the system of the present invention can also be used in a virtually unlimited array of personal management scenarios. For example, physicians' offices can automatically remind patients of appointments, and can offer the ability to reschedule. Airlines can automatically notify passengers when a flight is delayed or cancelled, and can provide the ability to reschedule. Users of online dating services, or any other classified advertising service, can be notified when someone responds to their ad, and can then be provided an opportunity to respond to the response, to request more information, or to schedule a meeting with the respondent. Financial companies, in another exemplary embodiment, can notify their customers when there is a problem with an account, such as an overdraft, or unusual activity on the account.

Commercial sales can also make use of the system of the present invention. For example, in another exemplary embodiment, a stock broker can automatically notify a customer when a stock of interest has dropped below a specified price and can allow the customer to purchase the stock. In another example, an on-line auction website can automatically notify a bidder regarding attainment of various bid objectives, such as, e.g., when his maximum bid has been exceeded and can provide the ability to allow the bidder to increase his bid.

In short, the system of the present invention can be used in any scenario where a user 110 is expecting an event or needs to be notified of a possible event and may not have access to any device other than a telephone or other mobile device, such as, e.g., a communications device, a computing device, a personal digital assistant (PDA), a mobile telephone, a multi-function voice enabled device, a voice-over-Internet Protocol (VoIP) device, or other mobile device. The examples presented here are not meant to limit the implementations of the invention in any way but are intended to further illustrate exemplary embodiments according to the present invention.

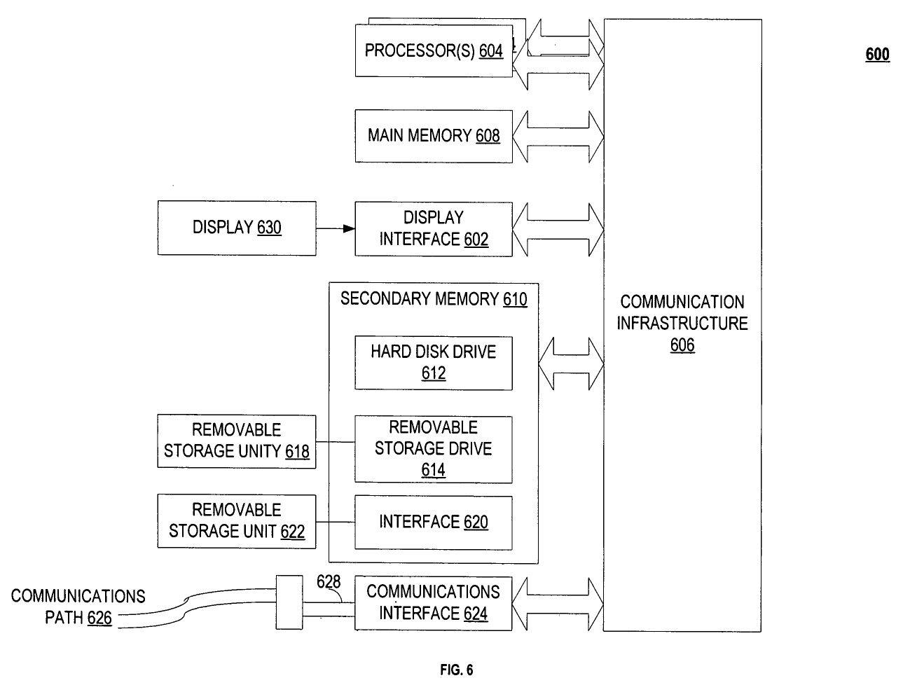

FIG. 6 depicts an exemplary embodiment of a computer system that can be used as in mobile device 112, voice services platform server 304, content management system 204, mail servers 312a-c, voice recognition unit 310, pollers 308a-b, text-to-speech synthesizer 208, event delivery by phone module 206, listeners 502a-c, call drivers 222, event stores 504, agents 506a-c, etc. The present invention (or any part(s) or function(s) thereof) may be implemented using hardware, software or a combination thereof and may be implemented in one or more computer systems or other processing systems. In fact, in one exemplary embodiment, the invention is directed toward one or more computer systems capable of carrying out the functionality described herein. An example of a computer system 600 is shown in FIG. 6. FIG. 6 depicts an exemplary embodiment of a block diagram of an exemplary computer system useful for implementing the present invention. Specifically, FIG. 6 illustrates an example computer 600 in a preferred embodiment is a personal computer (PC) system running an operating system such as, e.g., Windows 98/2000/XP, Linux, Solaris, OS/2, Mac/OS, or UNIX. However, the invention is not limited to these platforms. Instead, the invention can be implemented on any appropriate computer system running any appropriate operating system, such as Solaris, Irix, Linux, HPUX, OSF, Windows 98, Windows NT, OS/2, Mac OS, and any others that can support Internet access. In one exemplary embodiment, the present invention may be implemented on a computer system operating as discussed herein. Other components of the invention, such as, e.g., a computing device, a communications device, a telephone, a personal digital assistant (PDA), a pocket personal computer (PC), a handheld personal computer (PC), client workstations, thin clients, thick clients, proxy servers, network communication servers, remote access devices, client computers, server computers, routers, web servers, data, media, audio, video, telephony or streaming technology servers could also be implemented using a computer such as that shown in FIG. 6.

Various software embodiments are described in terms of this exemplary computer system. After reading this description, it will become apparent to a person skilled in the relevant art(s) how to implement the invention using other computer systems and/or architectures. The computer system 600 includes one or more processors, such as processors 604. The processor 604 is connected to a communication infrastructure 606 (e.g., a communications bus, cross-over bar, or network).

Computer system 600 can include a display interface 602 that forwards graphics, text, and other data from the communication infrastructure 606 (or from a frame buffer, not shown) for display on the display unit 630.

The computer system 600 also includes a main memory 608, such as random access memory (RAM), and a secondary memory 610. The secondary memory 610 can include, for example, a hard disk drive 612 and/or a removable storage drive 614, representing a floppy diskette drive, a magnetic tape drive, an optical disk drive, a compact disk drive CD-ROM, etc. The removable storage drive 614 reads from and/or writes to a removable storage unit 618 in a well known manner. Removable storage unit 618, also called a program storage device or a computer program product, represents a floppy disk, magnetic tape, optical disk, compact disk, etc. which is read by and written to by removable storage drive 614. As will be appreciated, the removable storage unit 618 includes a computer usable storage medium having stored therein computer software and/or data.

In alternative exemplary embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., those found in video game devices), a removable memory chip (such as, e.g., an erasable programmable read only memory (EPROM), or programmable read only memory (PROM) and associated socket, and other removable storage units 622 and interfaces 620, which allow software and data to be transferred from the removable storage unit 622 to computer system 600.

Computer 600 can also include an input device such as (but not limited to) a mouse or other pointing device such as a digitizer, and a keyboard or other data entry device (none of which are labeled).

Computer 600 can also include output devices, such as, for example, display 630, and display interface 602. Computer 600 can include input/output (I/O) devices such as, e.g., communications interface 624, cable 628 and communications path 626. These can include, e.g., a network interface card, and modems (neither are labeled). Communications interface 624 allows software and data to be transferred between computer system 600 and external devices. Examples of communications interface 624 may include a modem, a network interface (such as, e.g., an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, an radio frequency (RF) link and other communications channels.

In this document, the terms “computer program medium” and “computer readable medium” are used to generally refer to media such as, e.g., removable storage drive 614, a hard disk installed in hard disk drive 612, and signals 628. These computer program products provide software to computer system 600. The invention is directed to such computer program products.

Computer programs (also called computer control logic), including object oriented computer programs, are stored in main memory 608 and/or the secondary memory 610 and/or removable storage units 614, also called computer program products. Such computer programs, when executed, enable the computer system 600 to perform the features of the present invention as discussed herein. In particular, the computer programs, when executed, enable the processor 604 to perform the features of the present invention. Accordingly, such computer programs represent controllers of the computer system 600.

In another exemplary embodiment, the invention is directed to a computer program product comprising a computer readable medium having control logic (computer software) stored therein. The control logic, when executed by the processor 604, causes the processor 604 to perform the functions of the invention as described herein. In another exemplary embodiment where the invention is implemented using software, the software may be stored in a computer program product and loaded into computer system 600 using removable storage drive 614, hard drive 612 or communications interface 624. The control logic (software), when executed by the processor 604, causes the processor 604 to perform the functions of the invention as described herein. The computer software can run as a standalone software application program running atop an operating system, or can be integrated into the operating system.

In yet another embodiment, the invention is implemented primarily in hardware using, for example, hardware components such as application specific integrated circuits (ASICs), or one or more state machines. Implementation of the hardware state machine so as to perform the functions described herein will be apparent to persons skilled in the relevant art(s).

In yet another exemplary embodiment, the invention is implemented using a combination of both hardware and software.

The invention may be used, for example, in conjunction with a product registration system. In one example, a manufacturer may use the notification function of the present invention to inform registered customers of new product features, or of product defects or recalls. Similarly, customers may be notified when the warranty on a registered product is about to expire, with the option to purchase extended warranty coverage.

In another example, the notification function may be integrated into a voice-responsive product registration system. Such a system may allow a product purchaser to call in to an automated, voice-responsive system to register the purchased product. The purchaser may be presented with any number of questions about the product purchased, product preferences, personal interests, etc. The purchaser's verbal answers may be captured and stored in a database. A response to the questions may trigger a notification event. For example, if the purchaser indicates an interest in a complementary product, a notification may be sent to a sales agent about the complementary product to follow-up with the purchaser. Or, the purchaser may indicate an interest in features that are not yet available, and a notification may be sent to the purchaser when those features become available.

In another example, the notification function may be used in conjunction with a broadcast voice notification system that may speed and simplify the notification process. The broadcast voice notification system “pushes” important information or notices to individual recipients with security, delivery authentication, and single-point activation. The broadcast voice notification system's secure voice alert administration is easy and intelligent, and may allow the user to select people to notify and to make choices on-the-fly, even to monitor who has been contacted moment by moment.

The broadcast voice notification system may provide a simple web interface, which may allow a phone list to be instantly created or recalled, a message to be typed (or pasted), and sent to many people simultaneously. The broadcast voice notification system may provide a seamless broadcasting system that gets a message delivered quickly.

The broadcast voice notification system may contact all the people on a list at once, reading the message to them when they answer the phone. The user who originates the message may monitor its broadcast in real-time through a computer-based user interface. The user interface may show if a call attempt fails, and the user may then try again when the time is right.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for product registration comprising the steps of:
receiving a customizable set of questions to be posed to a user;
receiving an incoming telephone call at an automated registration system from a user registering a product;
prompting a user with said set of questions and recognizing user responses to said set of questions with a voice recognition system;
storing said user responses; and
sending outbound telephonic notifications based on said user responses receiving user input on notification criteria.

2. The method of claim 1, wherein notification criteria comprise at least one of:
a product recall alert;
a warranty expiration alert; or
a new features alert.

3. The method of claim 1, further comprising transferring the user to a live agent when the user requests more information.

4. A voice services system comprising:
a voice services platform comprising a content management system;
a text-to-speech system for synthesizing speech from text coupled to said voice services platform;
a notifier coupled to said voice services platform; and
a product registration system coupled to said notifier, wherein said product registration system comprises:
a customizable set of questions to be posed to a user;
a voice recognition system, adapted to prompt a user with said set of questions and to recognize user responses to said set of questions;
a store, adapted to store said user responses; and
a call router, adapted to transfer said user to a live agent;
wherein said notifier is adapted to send outbound telephonic notifications based on said user responses.

5. A method for notifying a user of a message comprising the steps of:
receiving a message to broadcast;
receiving a list of people to contact, said list comprising at least one telephone number for each person on said list;
contacting each person on said list substantially simultaneously by telephone;
requesting a user response indicating a live person answered said telephone;
receiving said user response indicating the live person answered said telephone;
speaking said message to said live person with a text-to-speech system; and
displaying on a user interface whether each telephone call was answered by a live person.

6. The method of claim 5, further including:
requesting a user authentication;
determining if said user authentication is valid; and
not speaking said message if said user authentication is not valid.

7. The method of claim 5, further comprising:
receiving user input comprising an action to take based on said message.
